(19) United States
(12) Patent Application Publication
(10) Pub. No.: US 2021/0157269 A1
(43) Pub. Date: May 27, 2021

(54) MECHANICAL TIMEPIECE REGULATOR COMPRISING A CONSTANT FORCE ESCAPEMENT

(71) Applicant: CSEM Centre Suisse d'Electronique et de Microtechnique SA - Recherche et Développement, Neuchâtel (CH)

(72) Inventors: Olivier LAESSER, La Chaux-de-Fonds (CH); Gregory MUSY, Le-Mont-sur-Lausanne (CH); François BARROT, Erlach (CH); Yves PETREMAND, Yverdon-les-Bains (CH)

(21) Appl. No.: 16/953,414

(22) Filed: Nov. 20, 2020

(30) Foreign Application Priority Data
Nov. 22, 2019 (CH) CH01474/19

(51) Int. Cl. G04B 15/14; G04B 15/12; G04B 15/08

(52) U.S. Cl. CPC G04B 15/14; G04B 15/08; G04B 15/12

(57) ABSTRACT

The present invention relates to a mechanical timepiece regulator comprising a constant force escapement and an oscillator; the oscillator comprising a balance connected to an elastic return element of the balance returning the balance into a plane of oscillation such that the balance is able to oscillate; the escapement comprising an escapement wheel and an anchor part, integrated in the balance, an entry pallet lever and an exit pallet lever, each of the pallet levers being mounted on a pallet lever elastic return element configured to be wound by the escapement wheel; the pallet levers being configured to block or release the escapement wheel between two windings of the pallet lever elastic return elements and to cooperate with the anchor part so as to transmit to the balance the energy stored in the pallet lever elastic return elements with each oscillation alternation of the balance.

### TECHNICAL FIELD

The present invention relates to a mechanical timepiece regulator mechanism comprising a constant force and self-starting escapement, in addition to an oscillator. The present invention further relates to a method for manufacturing the regulator.

### PRIOR ART

The energy source of a mechanical watch is the mainspring. This mainspring supplies the oscillator of the watch via a gear train and an escapement. During the operation of the watch, the mainspring is progressively discharged. In other words, the torque of the barrel suppled to the oscillator reduces until it is too weak to activate the oscillator, causing the stoppage of the watch. In the case of a conventional escapement (typically a Swiss lever escapement) the reduction in the torque of the barrel disrupts the oscillator and causes a reduction in the amplitude thereof. Unfortunately, even the best timepiece oscillator has a dependency between its amplitude and its frequency. Thus a variation in amplitude causes a variation in frequency, also called the “isochronism defect” of the oscillator. This isochronism defect represents one of the principal sources of inaccuracy of the mechanical watch.

Two approaches may be conceived for minimizing the disruption of the oscillator by varying the torque of the barrel. Naturally, these two approaches may be used simultaneously. The first approach is to design a timepiece regulator (oscillator and escapement) having an isochronism defect which is as small as possible in the operating amplitude range of the oscillator. The second approach is to minimize the variation in the quantity of energy supplied to the oscillator during the discharge of the barrel in order to obtain an amplitude of the oscillator which is as constant as possible. In order to achieve this, it is conceivable to intervene directly in the region of the barrel, on the gear train, or even the escapement. In the last case, this is called the “constant force” escapement: the quantity of energy transmitted with each impulse of the escapement to the oscillator is thus as constant as possible during the operation of the watch.

One of the first constant force escapements is the escapement of the inventor and watchmaker A. Breguet going back to the end of the 18th century. As a result, several improvements to this escapement have been proposed, in particular in the patent documents US 59658, DE 42856, GB 710951, CH 711608 and EP 3153935. These escapements are generally composed of a pallet lever (also called “lever” or even “stop lever”) connected to a spring and transmitting the energy stored by the spring from the pallet lever to an oscillator. A first detent actuated by the balance of the oscillator releases the pallet lever at the moment of the impulse and a second detent actuated by the pallet lever releases the escapement wheel after the impulse. Once released, the escapement wheel rewinds the pallet lever and locks it to its detent until the next impulse. The principal drawback of these escapements is that they are not “self-starting”, i.e. the oscillator is not able to start to oscillate of its own accord once the barrel is rewound. The balance thus has to be started manually or by a mechanism permitting it to start. Moreover, if an external shock applied to the watch has stopped the balance, said balance might not be able to restart on its own. This absence of self-starting is due to the fact that all of these escapements are called “deadbeat” escapements, i.e. the escapement only transmits energy to the balance in one alternation out of two: if the balance is stopped during the alternation when energy is not transmitted thereto, it will not be able to restart (without external intervention).

### BRIEF SUMMARY OF THE INVENTION

The present invention relates to a mechanical timepiece regulator comprising a constant force escapement and an oscillator; the oscillator comprising a balance cinematically connected to an elastic return element of the balance returning the balance into a plane of oscillation such that the balance is able to oscillate therein; the escapement comprising an escapement wheel and an anchor integrated in the balance; the escapement also comprising an entry pallet lever and an exit pallet lever, each being connected to a pallet lever elastic return element configured to be wound by the escapement wheel with each oscillation alternation of the balance; the pallet levers being configured to block (resting phase) the escapement wheel between two windings of the pallet lever elastic return elements and to cooperate with the anchor so as to transmit to the balance (impulse phase) the energy stored in the pallet lever elastic return elements with each oscillation alternation of the balance.

In the regulator of the present invention, the “constant force” effect is obtained due to the fact that the escapement wheel, the torque thereof depending on the reduction in torque of a barrel, does not transfer its energy directly to the balance but alternately winds the pallet lever elastic return elements of each pallet lever (or: of each of the pallet levers). By successively being unwound at each alternation, these pallet lever elastic return elements permit the pallet levers to transfer their energy to the balance (an impulse phase by oscillation alternation of the balance). As the pallet levers are always wound to the same angle by the escapement wheel and the stiffness of the pallet lever elastic return elements is dimensioned to be constant over the winding range, the impulse force of the pallet levers on the balance is also constant during the discharge of the barrel. In contrast to escapements of the prior art, the escapement of the invention is self-starting since the use of two pallet levers makes it possible to transmit an impulse to the balance with each alternation of the oscillator.

The present invention further relates to a method for manufacturing the regulator.

### BRIEF DESCRIPTION OF THE FIGURES

Exemplary embodiments of the invention are shown in the description illustrated by the accompanying figures, in which:

FIG. 1 shows a timepiece regulator mechanism, according to an embodiment;

FIG. 2 shows a partial view of the regulator of FIG. 1;

FIGS. 3a-c show a partial view of the regulator during a resting phase (FIG. 3a), a release phase (FIG. 3b) and an impulse phase;

FIG. 4 shows the regulator during the resting phase;

FIG. 5 shows the regulator during the release phase;

FIG. 6 shows the regulator during the first drop of the entry pallet lever;

FIG. 7 shows the regulator during the impulse phase;

FIG. 8 shows the regulator during the second drop of the entry pallet lever;

FIG. 9 shows the regulator during the winding phase;

FIG. 10 shows the regulator at the end of the winding phase;

FIG. 11 shows the regulator according to a first exemplary embodiment;

FIG. 12 shows a detail of a system for tuning the isochronism of the regulator, according to an embodiment;

FIG. 13 shows a first component forming the regulator according to an embodiment;

FIG. 14 shows a second component forming the regulator according to an embodiment;

FIG. 15 shows a third component forming the regulator according to an embodiment;

FIG. 16a shows a partial view of the regulator according to a second exemplary embodiment;

FIG. 16b shows a detail of the pallet levers of the regulator of FIG. 12a

FIG. 16c shows the regulator at the end of the release of the second entry detent, according to the second exemplary embodiment; and

FIG. 16d shows a detail of the pallet lever release arms in the case of malfunction of the exit detent.

### EXEMPLARY EMBODIMENT(S) OF THE INVENTION

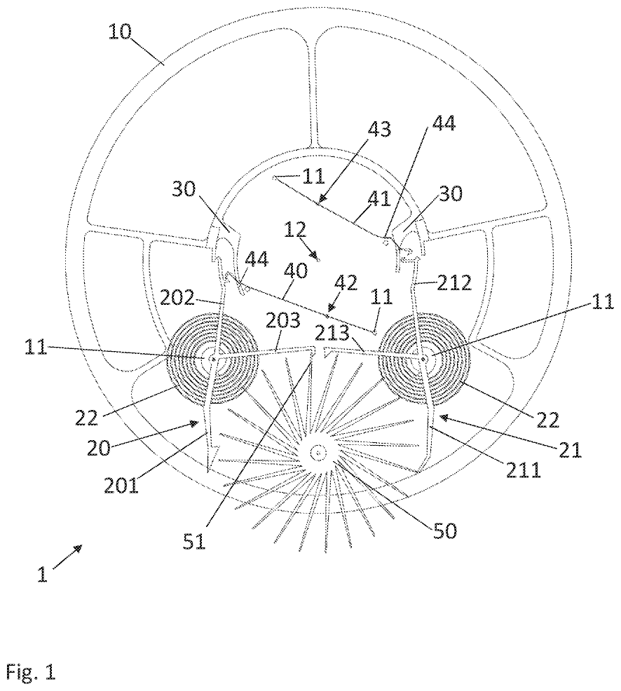

FIG. 1 shows a mechanical timepiece regulator 1 according to an embodiment. The regulator 1 comprises an oscillator including a balance 10 which is connected to an elastic return element (not shown) of the balance. The elastic return element of the balance 10 is connected to a fixed base (not shown). The balance 10 may be a timepiece balance in the conventional sense of the term, thus forming an oscillator of the balance-spring type. The invention, however, is also applicable to other types of oscillators and the balance 10 may thus be connected to elastic return elements which take different forms from the conventional timepiece spiral spring. An anchor part 30 is fixed to the balance 10 (in the example of FIG. 1, the anchor part 30 is entirely integrated in the balance 10).

The regulator 1 also comprises an escapement of the “constant force” type, comprising an entry pallet lever 20 and an exit pallet lever 21, each of the pallet levers 20, 21 being mounted on a pallet lever elastic return element 22. The pallet lever elastic return element 22 is connected, on the one hand, to the pallet lever 20, 21 and, on the other hand, to a fixed base (not shown). It will be noted that the terms “lever” or “stop lever” are often used to denote said pallet lever 20, 21.

The entry pallet lever 20 and the exit pallet lever 21 are configured so as to cooperate with teeth 51 of an escapement wheel 50. The escapement wheel 50 is subjected to a torque from an energy storage mechanism (not shown) and arranged to wind the pallet levers 20, 21 with each oscillation alternation of the balance.

According to one embodiment, the escapement comprises an entry detent 40 cooperating with the entry pallet lever 20 and an exit detent 41 cooperating with the exit pallet lever 21. The entry 40 and exit 41 detents each consist of a flexible blade having an end fixed to a fixed base 11 and a free end, the free end comprising a detent resting plane 44. Each of the entry 40 and exit 41 detents may also consist of a rigid detent, comprising the detent resting plane 44, returned by a spring. Generally, each of the entry 40 and exit 41 detents comprises a part consisting of the detent resting plane 44 cooperating with the pallet lever 20, 21 and a flexible part serving as a return spring and having an end fixed to the fixed base 11. The entry 40 and exit 41 detents are each configured so that their free end may pivot about a detent center of rotation 42, 43. The entry detent 40 and the exit detent 41 make it possible to avoid that during the additional arc of the balance 10 (arc covered by the balance without interaction with the escapement, in this case one of the two detents nevertheless remains in contact with the balance), the pallet levers 20, 21 (the elastic return elements thereof having been rewound by the escapement wheel 50) come to bear against the anchor part 30 of the balance 10 which would decelerate the balance. In principle, the use of these detents thus makes it possible to reduce the energy losses of the system.

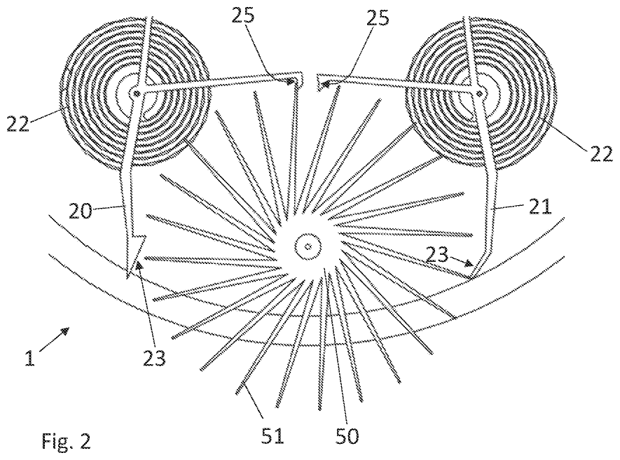

FIG. 2 shows a partial view of the regulator 1, the pallet levers 20, 21 with their pallet lever elastic return elements 22, in addition to the escapement wheel 50 being visible therein. The teeth 51 of the escapement wheel 50 cooperate with a pallet lever resting plane 25 of the entry pallet lever 20 and a pallet lever resting plane 25 of the exit pallet lever 21, and with a pallet lever winding plane 23 of the entry pallet lever 20 and a pallet lever winding plane 23 of the exit pallet lever 21.

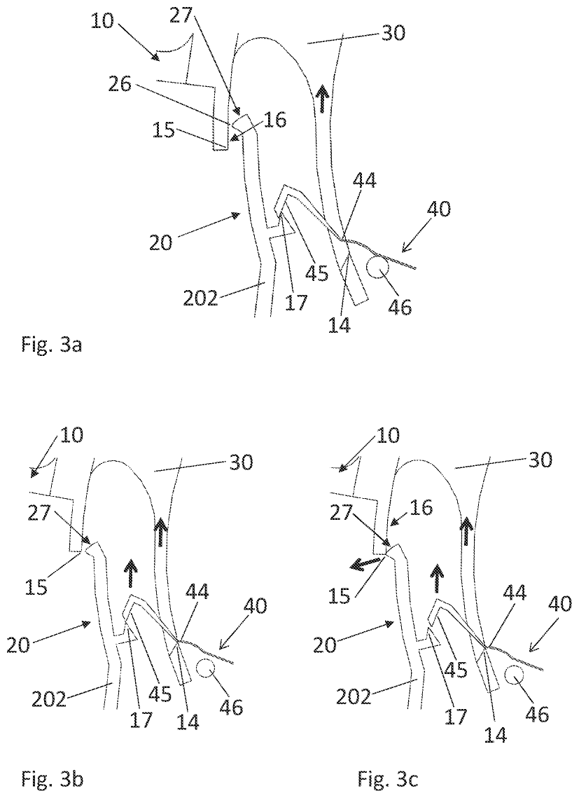

FIGS. 3a-c show a partial view of the regulator in which the anchor part 30, a portion of the entry pallet lever and the entry detent 40 are visible. During normal operation of the regulator 1, a pallet lever impulse plane 27 of the entry pallet lever 20 and of the exit pallet lever (not shown in these figures) cooperates solely with an anchor impulse beak 15 of the anchor part 30. The entry detent 40 and the exit detent 41 cooperate via the detent release plane 44 with the release beak 14 of the anchor part 30. The entry pallet lever 20 and the exit pallet lever 21 cooperate with a detent resting plane 45 of the entry detent 40 and the exit detent 41 by means of a pallet lever resting beak 17. It is clear that the resting plane could be implemented on the pallet lever and the beak in the region of the detent.

The anchor part 30 is provided with a back-up resting plane 16 on which an end of the pallet lever impulse plane 26 may bear in the case of malfunction of the entry detent 40 and/or the exit detent 41, for example following a shock causing the release of one of the detents 40, 41.

Detailed Operation

Once again with reference to FIG. 2, when the escapement wheel 50 is released by the entry pallet lever, its rotation causes the rewinding of the exit pallet lever 21 which has just provided an impulse to the balance 10. In order to achieve this, one of the teeth 51 of the escapement wheel 50 bears against the pallet lever winding plane 23 of the exit pallet lever 21, pivoting this exit pallet lever in the counterclockwise direction and winding the pallet lever elastic return element 22 of the exit pallet lever 21. Just before completing the winding of the exit pallet lever 21, a further tooth 51 of the escapement wheel 50 comes into contact with the pallet lever resting plane 25 of the entry pallet lever 20 which blocks the rotation of the escapement wheel 50. The escapement wheel 50 then blocks the exit pallet lever 21 in its wound position, whilst still being blocked itself by the entry pallet lever 20.

During the operation of the regulator 1, it is possible to distinguish four principal phases of the escapement during the oscillation alternation of the balance 10: resting, release, impulse and winding, in addition to the two drops of the pallet lever 20, 21 between the principal phases.

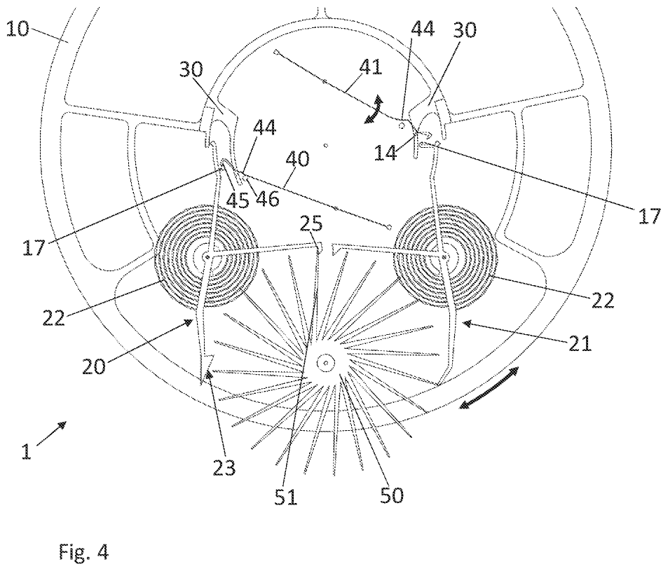

FIG. 4 shows the regulator 1 during the resting phase occurring during the additional arc of the balance 10. During the entry resting phase, the entry pallet lever 20, the exit pallet lever 21 and the escapement wheel 50 are blocked and therefore static. The detent 40 is also static. Only the balance 10 pivots, in the counterclockwise direction and then in the clockwise direction, driven with the detent 41.

The detent release plane 44 of the exit detent 41 is in contact with an anchor release beak 14 of the anchor part 30. The entry detent 40 rests against an abutment 46 which is fixed to the fixed part (fixed base) and locks the entry pallet lever 20 in the wound position (i.e. the pallet lever elastic return element 22 is wound). The escapement wheel 50 is blocked by the entry pallet lever 20, the pallet lever resting plane 25 thereof being in engagement with one of the teeth 51 of the escapement wheel 50. The exit pallet lever 21 is held in the wound position by the escapement wheel 50.

During the resting phase of the entry pallet lever, the pallet lever resting beak 17 is located on the detent resting plane 45 of the entry detent 40 which is slightly pre-loaded on its fixed abutment 46 (see FIG. 3a). The rotation of the entry pallet lever 20 is thus blocked by the entry detent 40.

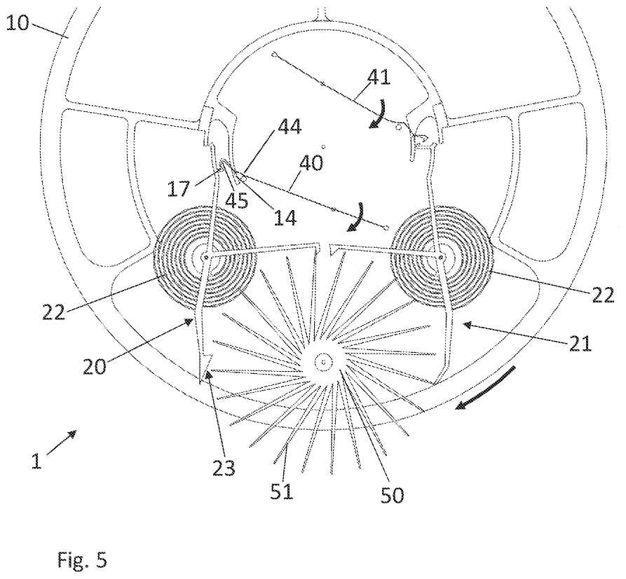

FIG. 5 shows the regulator 1 during the release phase of the entry pallet lever. During this phase, the balance 10 rotates in the clockwise direction and unlocks the entry pallet lever 20 entraining the entry detent 40. As illustrated in FIG. 3b, the rotation of the balance 10 in the clockwise direction (indicated by the arrow) causes the release of the entry detent 40 by means of the anchor release beak 14 which pushes onto the detent release plane 44 of the entry detent 40. The detent resting plane 45 slides on the pallet lever resting beak 17 until the release of the entry pallet lever 20. The torque of the pallet lever elastic return element 22 causes the entry pallet lever 20 to pivot (in the direction indicated by the arrow in FIG. 3c) and thus causes the pallet lever impulse plane 27 to come into contact with the anchor impulse beak 15. The entry pallet lever 20 then transmits its energy to the balance 10.

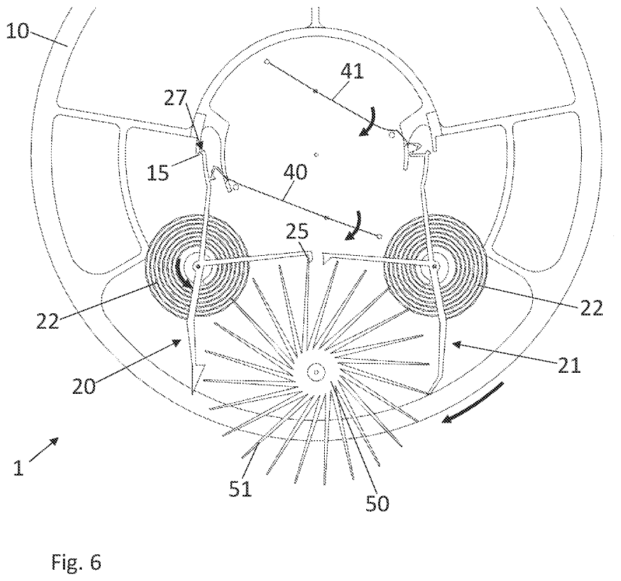

FIG. 6 shows the regulator 1 just at the end of the first drop of the entry pallet lever 20. The entry pallet lever 20, which has just been released from the entry detent 40, briefly drops before the pallet lever impulse plane 27 of the, entry pallet lever 20 reaches the anchor impulse beak 15.

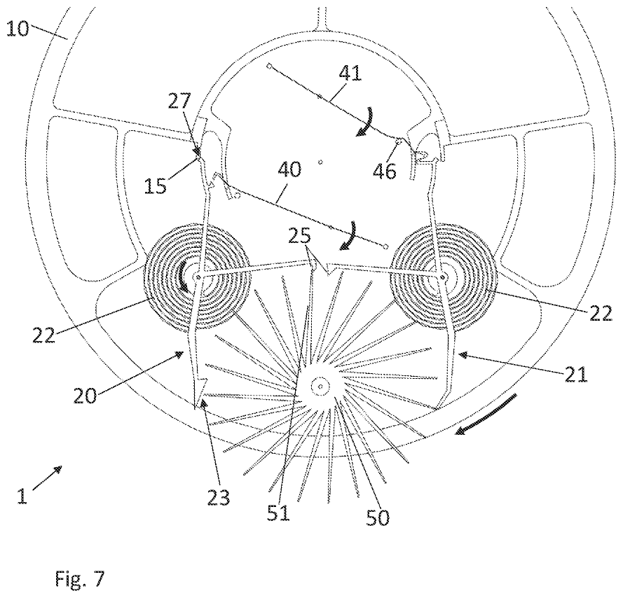

FIG. 7 shows the regulator 1 during the impulse phase. The impulse phase between the entry pallet lever 20 and the balance 10 takes place simultaneously with the release of the escapement wheel 50, thus releasing the escapement wheel. The entry pallet lever 20 released from the entry detent 40 pivots due to the torque of the pallet lever elastic return element 22 in the counterclockwise direction (see FIG. 3c) and comes into contact with the anchor impulse beak 15 in the region of the pallet lever impulse plane 27. The rotation of the entry pallet lever 20 also causes the release of one of the teeth 51 of the escapement wheel 50 from contact with the pallet lever resting plane 25 of the entry pallet lever 20, thus releasing the escapement wheel 50.

The moment when the impulse is completed coincides with the end of the release of the escapement wheel 50 and with the impact between the exit detent 41 and its fixed abutment 46. At the end of the impulse phase, the exit detent 41 is no longer in contact with the balance 10 but bears against its fixed abutment 46. The pallet lever winding plane 23 of the entry pallet lever 20 comes into contact with one of the teeth 51 of the escapement wheel 50 which has just been released.

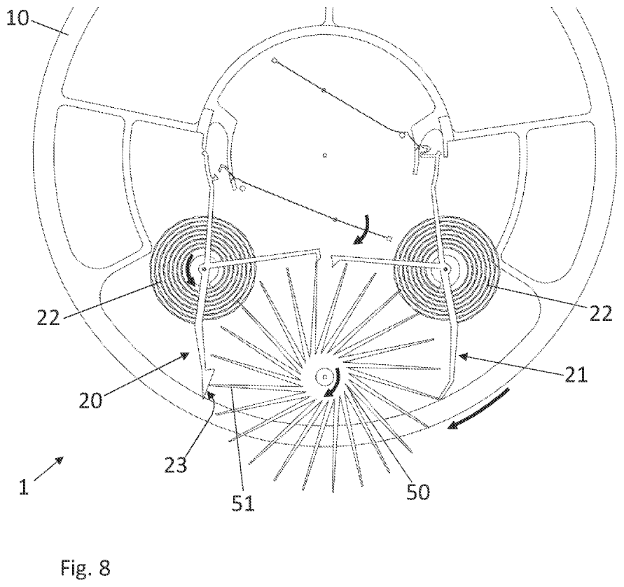

FIG. 8 shows the regulator 1 just at the end of the second drop of the entry pallet lever 20. This drop takes place during the additional arc of the balance 10. After the end of the impulse, the entry pallet lever 20, which has just given its impulse to the balance 10, is free to pivot very briefly, as is the escapement wheel 50. The entry pallet lever 20 is rapidly engaged in the region of its pallet lever winding plane 23 with one of the teeth 51 of the escapement wheel 50; the tooth 51 which is then in engagement stops the pivoting of the entry pallet lever 20.

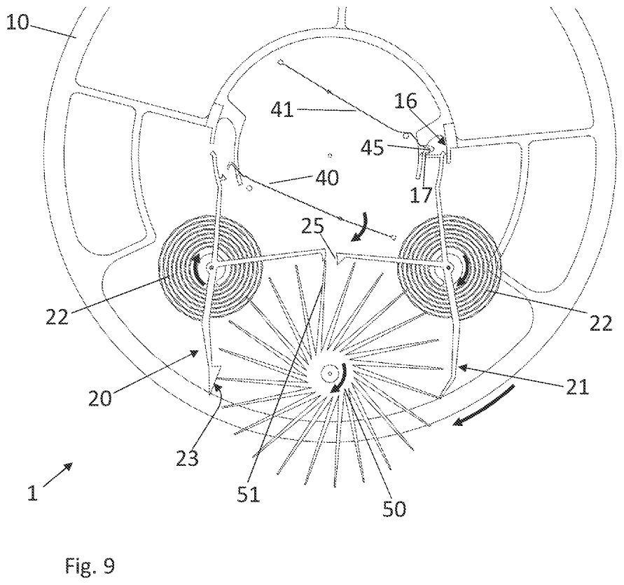

FIG. 9 shows the regulator 1 during the winding phase. The winding phase starts by the impact between the pallet lever winding plane 23 of the entry pallet lever 20 and one of the teeth 51 of the escapement wheel 50. The rotation of the escapement wheel 50 actuated by the torque of the gear train (not shown) then rewinds the pallet lever elastic return element 22 of the entry pallet lever 20 (in the clockwise direction).

At the start of the winding of the entry pallet lever 20, the rotation of the escapement wheel 50 slides one of its teeth 51 outside the pallet lever winding plane 23 of the exit pallet lever 21, releasing said exit pallet lever. The exit pallet lever 21, now free to pivot, is entrained by the torque of its pallet lever elastic return element 22 in the clockwise direction. The pallet lever resting beak 17 of the exit pallet lever 21 then comes into engagement with the detent resting plane 45 of the exit detent 41, thus locking the exit pallet lever 21 and preventing frictional contact with the back-up resting plane 16 of the balance 10 (see FIG. 3a).

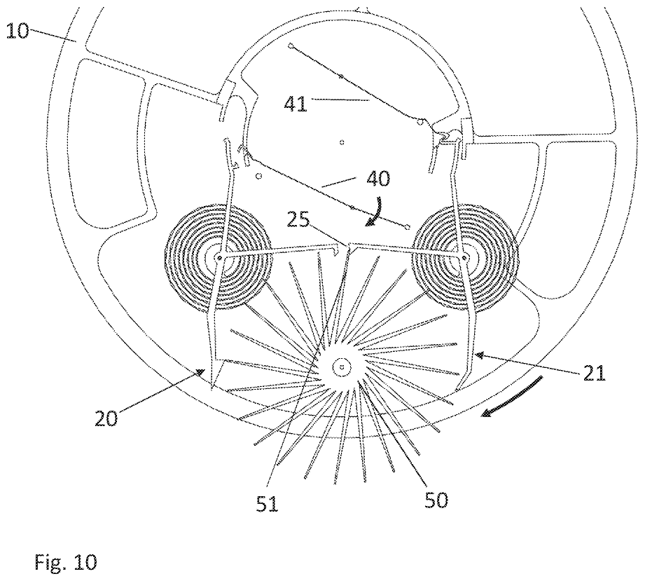

The winding phase of the entry pallet lever 20 is completed when one of the teeth 51 of the escapement wheel 50 comes into contact with the pallet lever resting plane 25 of the exit pallet lever 21 (FIG. 10). At this moment, the entry pallet lever 20 is rewound. The phases of resting, release, impulse, drop and winding of the exit pallet lever 21 follow. These phases are similar to those described above for the entry pallet lever 20.

The two pallet levers 20, 21 and respectively the two detests 40, 41 play an equivalent role and act alternately during the operation of the escapement.

The description of the above paragraphs is also applicable by replacing the entry pallet lever 20 with the exit pallet lever 21.

The sequence of phases described here is that where the entry pallet lever 20 is principally active and the balance 10 rotates in the clockwise direction. When the oscillator rotates in the counterclockwise direction, a second sequence follows where the roles between the entry and exit functions are reversed. Since the escapement is functionally symmetrical between the entry and exit, a description of the second sequence is thus redundant.

The blocking of the escapement wheel 50 by the pallet levers 20, 21 makes it possible to produce the essential function of counting the alternations of the oscillator by the escapement and thus synchronizing the gear train of a watch to the frequency of the oscillator. The second essential function of an escapement is the supply of energy to the oscillator which is carried out in this case by means of the pallet levers 20, 21 which are successively wound by the escapement wheel before being released at each alternation by the balance, to which they transmit the winding energy stored in their elastic return element 22 during the so-called impulse phase.

It goes without saying that the present invention is not limited to the embodiment which has been described above and that various modifications and simple variants may be conceived by the person skilled in the art without departing from the scope of the present invention.

For example, the regulator 1 could function without the entry 40 and exit 41 detents (according to the object of desired performance—greater consumption or/and conventional oscillator). In this case, the pallet levers would drop onto the back-up resting plane 16 of the anchor part 30 after having been released by the escapement wheel 50 during the winding phase. This means that the pallet levers would have frictional contact with the balance (anchor part 30) during the entire resting phase of the escapement. This frictional contact between the pallet levers and the balance would be more significant than that caused by the contact between the anchor release beak 14 and the detent release plane 44. The energy consumption of the escapement is thus greater if the detents are eliminated.

An advantage of the regulator 1 of the invention is that the impulses are at “constant force”, i.e. the variation in the torque of the barrel during the course of its discharge barely effects the impulse force applied to the balance 10 by the pallet levers 20, 21. It is important that if the impulses are always of the same intensity, the amplitude of the balance 10 does not vary over the course of time and thus the frequency of the oscillator remains very stable (isochronism of the oscillations in a given amplitude range). This effect is obtained by the fact that the escapement wheel 50 does not directly transmit its energy to the balance 10 but rewinds the pallet lever elastic return elements 22 of the pallet levers 20, 21. The winding angle and the stiffness of the pallet lever elastic return element 22 define the impulse force (or torque) transmitted to the balance 10 by means of the pallet levers 20, 21. The winding angle and the stiffness are independent of the torque on the escapement wheel 50 and thus of the fluctuations of the torque of the barrel.

However, it should be noted that the frictional contact between the escapement wheel 50 and one of the pallet levers 20, 21 during the release of the escapement wheel 50, is produced simultaneously with the impulse phase: the oscillator is then be deprived of a very small part of the energy stored in the pallet lever elastic return element 22. This small quantity of energy dissipated by frictional contact varies with the torque on the escapement wheel 50 and thus with the torque of the barrel, making the amplitude of the balance 10 very slightly dependent on the discharge of the barrel.

Temperature and gravity could also have a slight influence on the stiffness of the pallet lever elastic return elements 22, which affects the impulse force and the amplitude of the oscillator. Thus it is necessary that the isochronism of the system is correct and that the pallet lever elastic return element 22 and/or the elastic return element of the balance 60 are thermally compensated over the temperature range for the use of the watch.

A further advantage of the regulator 1 of the invention is that its power consumption is approximately three times less than a regulator with a traditional Swiss anchor. This has two advantageous consequences. Firstly, the power reserve of a watch comprising such a regulator is greater. This means that the period of use of the watch before it stops is approximately three times longer than that of a conventional mechanical watch. Secondly, the mainspring takes three times as long to be discharged and thus its torque varies less over a given period of time. This means that the rate variation during this period of time is also less than that of a conventional mechanical watch during the same period of time.

The low power consumption is principally due to four factors. A first factor is the low amplitude of the balance 10, which is required so that it is able to be isochronic and insensitive to gravity. A second factor is the low inertia of the pallet levers 20, 21. This limits the loss of energy associated with the impact at the end of the impulse between the pallet lever winding plane 23 of the one of the pallet levers 20, 21 and one of the teeth 51 of the escapement wheel 50. The inertia of the escapement wheel 50 plays little role since in contrast to the pallet levers 20, 21, its maximum speed is low. A third factor is that the use of entry 40 and exit 41 detents make it possible to reduce the frictional contact during the resting phase (by avoiding direct contact between the pallet lever impulse beak 27 and the back-up resting plane 16 of the balance 10). Finally a fourth factor is the absence of frictional contact relative to the pivot function of the elastic return element of the balance and the pallet lever elastic return element, when these elastic return elements are produced by using pivots on flexible bearings.

The isochronism defect of the elastic return element of the balance 60 may be corrected by the detents 40, 41. A single detent 40, 41 bears against the balance 10 during the additional arc and the two detents 40, 41 are in contact with the balance 10 during the release phase and the impulse phase (which corresponds by definition to the angle of lift). Since the detents 40, 41 are flexible the overall stiffness of the regulator varies during the oscillation. The detents 40, 41 thus have the tendency to reduce the average stiffness of the oscillator at high amplitude. The return torque that the detents apply to the balance is also influenced by their preload torque (detents preloaded against their fixed abutment). This preload torque may be adjusted in order to compensate for the fact that when pivots on flexible bearings are used, such as for example a Wittrick pivot (see CH 709291 by the present applicant), in order to design the elastic return element of the balance 60 of the oscillator, said oscillator has the tendency to be more stiff, on average, at high amplitude.

A final advantage of the regulator 1 is that relative to other regulators having a constant force escapement, the regulator 1, if it is carefully dimensioned, may be made to be self-starting.

### First Exemplary Embodiment

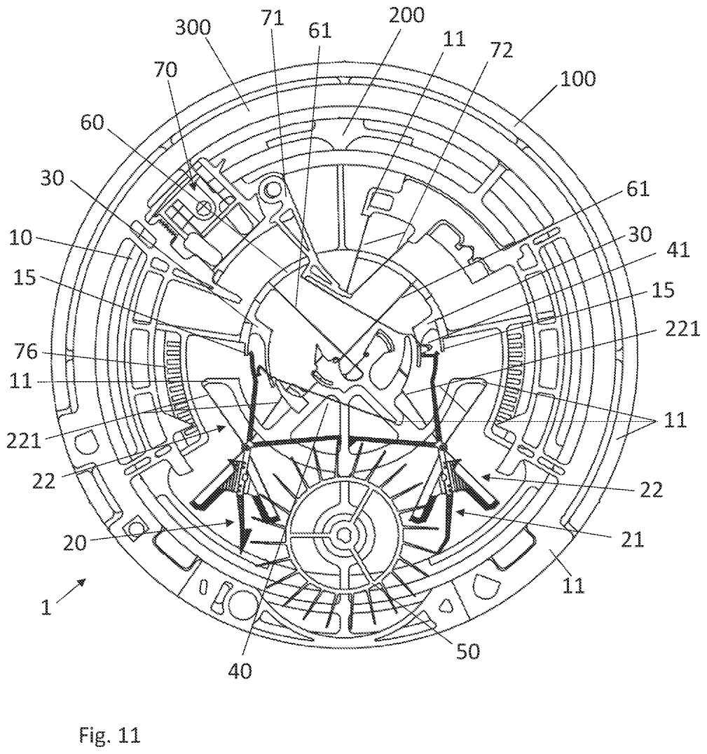

FIG. 11 shows the regulator 1 according to a first exemplary embodiment. In contrast to the configuration of the regulator 1 described in FIGS. 1 to 9, the regulator 1 according to the configuration of the first exemplary embodiment comprises an elastic return element of the balance 60 of the Wittrick type forming the pivot on the flexible bearing 61 of the oscillator. The pallet lever elastic return element 22 is also formed by a flexible pivot with two intersecting blades 221.

The isochronism defect of the flexible pivot of the Wittrick type 61 (balance elastic return element 60) of the oscillator is corrected by the detents 40, 41 of the escapement. A single detent 40, 41 bears against the balance 10 during the additional arc. The two detents 40, 41 are also in contact with the balance 10 during the release of the escapement wheel 50 and the impulse. Since the detents 40, 41 are flexible, the stiffness of the regulator 1 varies during the oscillation. The detents 40, 41 thus have the tendency to reduce the average stiffness of the oscillator at high amplitude. This compensates for the fact that during rotation of the oscillator the flexible bearing tends to be more stiff, on average, at high amplitude (which is true for the flexible pivot of the Wittrick type and for the majority of pivots on flexible bearings).

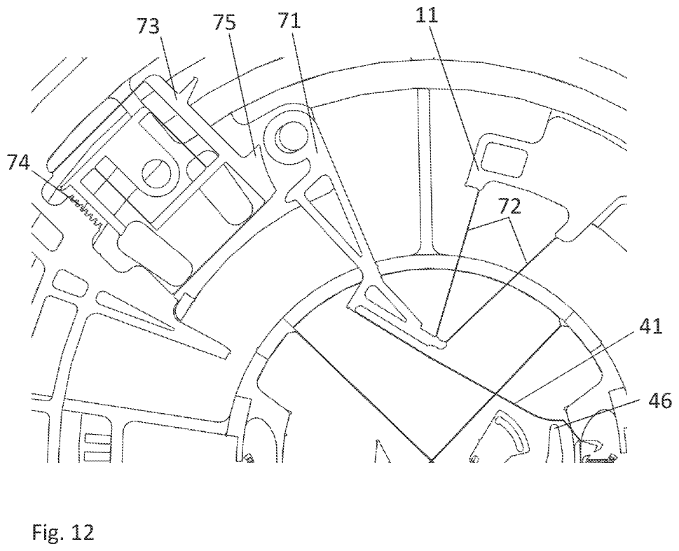

According to an embodiment, the regulator 1 comprises a system for tuning the isochronism 70. FIG. 12 shows a detail of the system for tuning the isochronism 70 which comprises a lever 71, on which the exit detent 41 is fixed, the lever 71 being guided in rotation by a flexible pivot of the RCC type 72. The system 70 also comprises an adjusting table 73 in translation on flexible bearings and provided with a system of notches 74 and an inclined plane 75.

The lever 71 makes it possible to tune the orientation of the exit detent 41 which enables the preload torque of the flexible exit detent 41 against its abutment 46 to be varied. The rotation of the lever 71 which varies the orientation of the exit detent 41 is guided by the flexible pivot of the RCC type 72 and is actuated by the adjustment table 73. The adjustment table 73 which is positioned using the notches 74 makes it possible to push the lever 71 via the inclined plane 75, thus causing the rotation of the lever 71 of the exit detent 41, which thus enables the preload torque of the exit detent 41 on the abutment 46 to be tuned. The level of the correction of the isochronism is thus proportional to this preload torque. A system for tuning the isochronism 70 as described above may also be conceived. for the entry detent 40.

An advantage of the regulator 1 according to this first exemplary embodiment is that the isochronism defect of the escapement naturally compensates for the isochronism defect of the elastic return element of the balance 60 of the Wittrick type 61. Moreover, the isochronism defect of the escapement is able to be tuned, which makes it possible to adapt to the defect of the oscillator which may vary from one oscillator to another due to inaccuracies of manufacture and assembly. Thus even in the presence of a slight variation in the amplitude of the balance 10 over time, the frequency is able to remain stable.

According to one embodiment, the regulator 1 according to the first implementation is formed by three components assembled together.

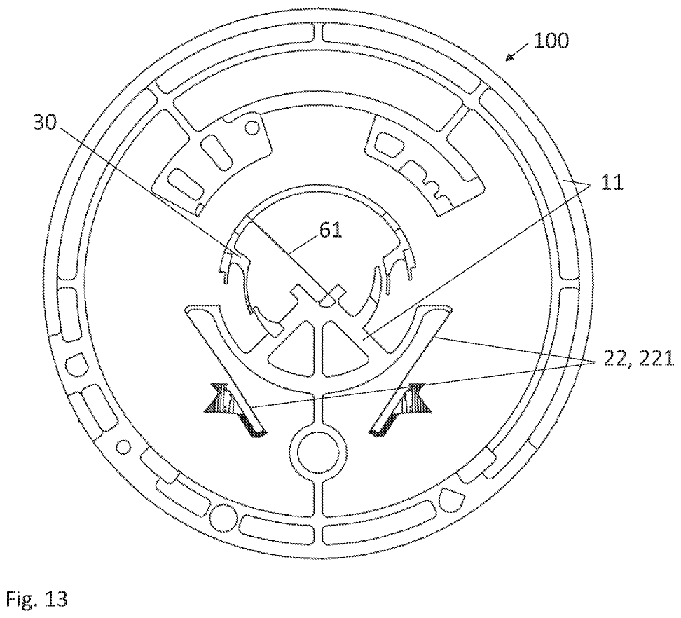

FIG. 13 shows the first component 100 comprising a blade 61 of the elastic return element of the balance 60 of the Wittrick type, the fixed base 11 permitting the interconnection of other components, the anchor part 30 and one of the blades 221 of the pallet lever elastic return element 22. In other words, the fixed base 11 constitutes the mechanical interface on which the two other components are fixed.

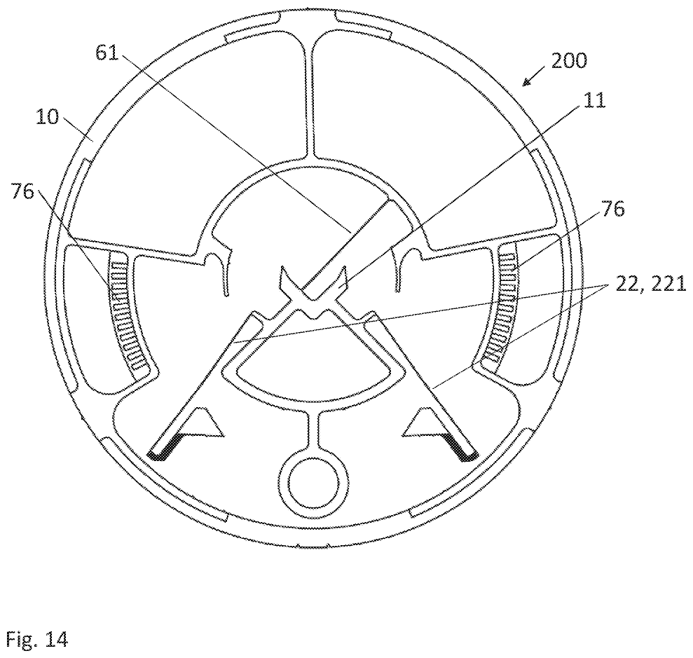

FIG. 14 shows a second component 200 comprising the other blade 61 of the elastic return element of the balance 60 of the Wittrick type, the other blade 221 of the pallet lever elastic return element 22, the felloe of the balance 10 and the apertures 76 serving for measuring the frequency of the oscillator. The second fixed base 11′ of the second component 200 is connected after assembly to the fixed base 11 of the first component 100. The first 100 and second components 200 thus form the oscillator of the system and a part of the escapement.

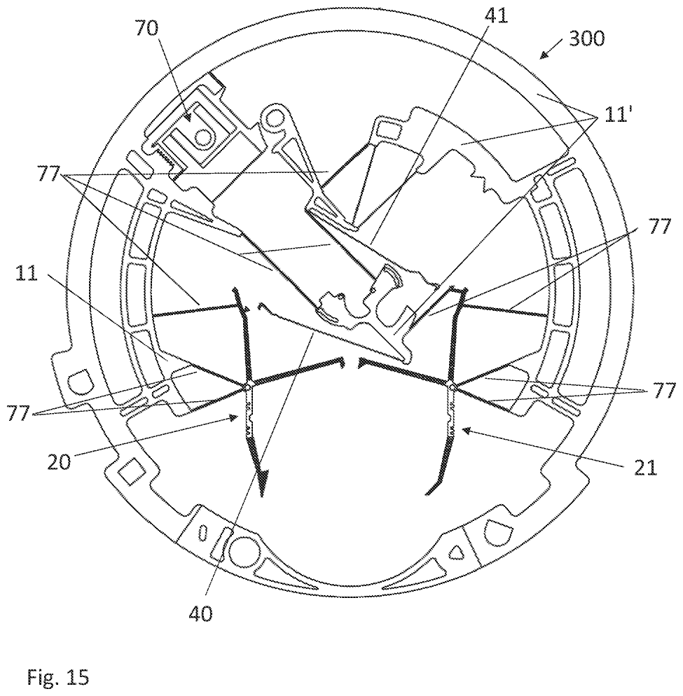

FIG. 15 shows a third component 300 comprising a third fixed base 11″ connected to the fixed base 11 of the first component 100. The third fixed base 11″ serves as a mechanical interface to fix the third component 300 to the fixed base 11 of the first component 100. The third component 300 also comprises the two pallet levers 20, 21 which in a first stage are fixed to the pallet lever elastic return elements 22 with intersecting blades, the blades thereof being distributed/located in the first component 100 and the second component 200, and then in a second stage disconnected from the remainder of the third component 300 by removing the sacrificial fasteners 77 once the three components 100, 200 and 300 are assembled. The third component 300 also comprises the two detents 40, 41, the fixed base of the entry detent 40 thereof being fixed by assembly to the fixed base 11 of the first component 100. The fixed base of the entry detent 40 is detached from the remainder of the third component 300, by removing the sacrificial fasteners 77, once the three components 100, 200, 300 are assembled. The fixed base of the entry detent 40 nevertheless remains connected to the third component 300 by means of the first component 100. Finally, the third component 300 also comprises the fixed base 11″ of the lever 71 (forming part of the system for tuning the isochronism 70) connected to the exit detent 41.

In particular, the elastic return element of the balance 60 of the Wittrick type consists of two blades 61 connected to one another at each of their ends. Each blade 61 has one end connected to the fixed base 11 and the other end connected to the balance 10. The blades 61 do not come into contact at the region of their intersection since they are not located in the same plane (it for this reason that each blade 61 is included in a different component: 100 and 200). According to one embodiment, the blades may intersect at approximately 12.5% of their length.

The blades 221 of the pallet lever elastic return element 22 may intersect at approximately 50% of their length. The advantage of the intersection ratio at 50% is that, for a given blade, the stiffness in rotation of the pallet lever elastic return element 22 is minimized (this is the flexible pivot with the lowest stiffness known). The ratio of 12.5% for the elastic return element of the balance 60 is more stiff but has the advantage of minimizing the displacement of the center of rotation of the balance 10 which plays a significant role in minimizing the flat hanging rate variation of the oscillator (i.e. the variation in frequency of the oscillator between a horizontal and vertical position of the watch relative to gravity).

### Second Exemplary Embodiment

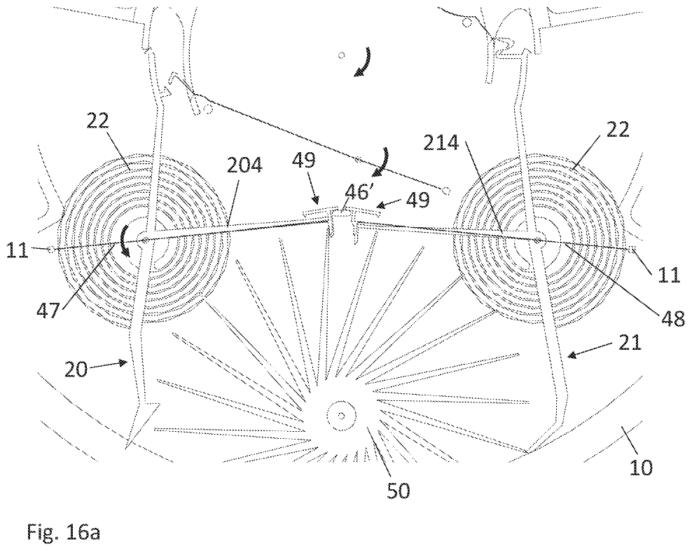

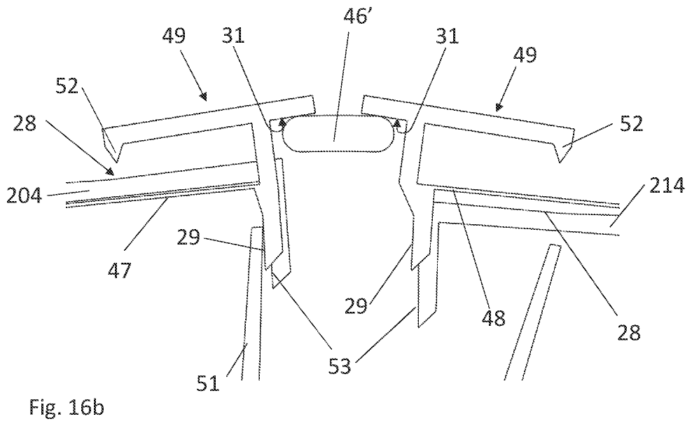

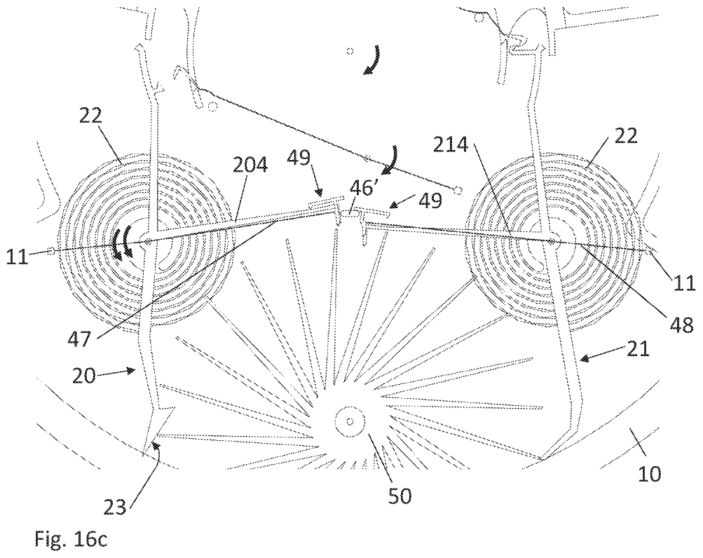

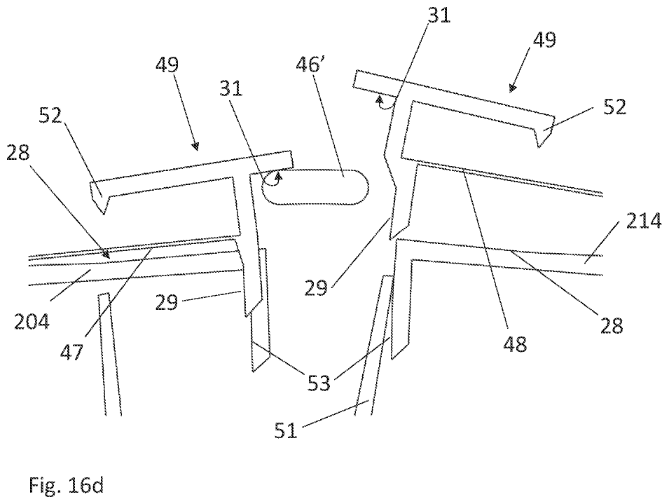

FIG. 16a shows a partial view of the regulator 1 according to a second exemplary embodiment. The entry pallet lever 20 comprises a pallet lever release arm 204 cooperating with a second entry detent 47. The exit pallet lever 21 also comprises a pallet lever release arm 214 cooperating with a second exit detest 48. The second entry detent 47 and the second exit detent 48 consist of a flexible blade fixed, at one end, to a fixed base 11 and having, at the other end, a second detent rigid part 49. The second detents 47, 48 may be preloaded against an abutment 46° in order to improve their stability. The regulator is shown in the impulse phase. In this second embodiment, the release of the escapement wheel 50 only starts once this impulse phase is complete.

FIG. 16b shows a detail of the pallet lever release arms 204, 214 during the impulse phase. The second detent rigid part 49 comprises a detent releasebeak 52 configured to cooperate with a releaseplane 28 located at one end of the pallet lever releasearm 204. The second detent stiff part 49 also comprises a second detent resting plane 29 designed to cooperate with the teeth 51 of the escapement wheel 50 in addition to an abutment plane 31 designed to bear against the fixed abutment 46′ when the second detent 47, 48 does not interact with the pallet lever 20, 21. As specified above, in this second embodiment the release has not taken place during the impulse, in contrast to the first embodiment. Thus in this impulse position, the tooth of the escapement wheel 51 bears against the resting plane) of the second entry detent 29. The second entry detent 9 is in the resting state since the release plane 28 of the entry pallet lever does not yet push against the detent release beak 52.

FIG. 16c shows the second embodiment of the regulator at the end of the release of the second entry detent 47. This release phase takes place following the impulse phase shown in FIGS. 16a-b. Now the release plane 28 of the entry pallet lever pushes against the detent release beak 52 causing the slippage of the resting plane of the second detent 29 against the tooth of the escapement wheel 51. At the end of this phase, the escapement wheel is released and is able to reload the entry pallet lever 20 via the pallet lever winding plane 23.

FIG. 16d shows a detail of the pallet lever release arms 204, 214 in the case of malfunction of the exit detent 48. More specifically, in the case of external shock applied to the watch, the second exit detent 48 could pivot and release the escapement wheel. In order to secure the escapement, a second back-up resting plane 53 connected to the exit pallet lever release arm 214 undertakes the resting of the escapement wheel 50. The entry resting function of the escapement wheel 50 is similarly protected in the case of malfunction of the second entry detent 47.

The regulator 1 according to the second embodiment makes it possible to disassociate the impulse phase from the release phase of the escapement wheel 50 which takes place just after the impulse. This makes it possible to prevent that the frictional contact between the escapement wheel 50 and the resting plane of the arm 29 at the moment of release does not influence the impulse force transmitted to the balance 10. Since the force of the frictional contact between the escapement wheel 50 and the resting plane of the arm 22 is due to the variation in torque of the barrel, the regulator 1 according to the second embodiment makes it possible to improve the constancy of the impulse force during the operation of the watch.

### REFERENCE NUMERALS USED IN THE FIGURES

1 Mechanical regulator
10 Balance
100 First component
11 Fixed base
11′ Second fixed base
11″ Third fixed base
12 Center of rotation of balance
14 Anchor release beak
15 Anchor impulse beak
16 Back-up resting plane
17 Pallet lever resting beak
20 Entry pallet lever
200 Second component
201 Entry pallet lever winding arm
202 Entry pallet lever impulse arm
203 Entry pallet lever resting arm
204 Entry pallet lever release arm
211 Exit pallet lever winding arm
212 Exit pallet lever impulse arm
213 Exit pallet lever resting arm
214 Exit pallet lever release arm
21 Exit pallet lever
22 Pallet lever elastic return element
221 Pallet lever elastic return element blade
23 Pallet lever winding plane
25 Pallet lever resting plane
26 End of pallet lever impulse plane
27 Pallet lever impulse plane
28 Pallet lever release plane
29 Arm resting plane
30 Anchor part
300 Third component

31 Abutment plane

40 Entry detent

41 Exit detent

42 Entry detent center of rotation

43 Exit detent center of rotation

44 Detent release plane

45 Detent resting plane

46 Fixed abutment

46′ Second detent fixed abutment

47 Second entry detent

48 Second exit detent

49 Second detent rigid part

50 Escapement wheel

51 Tooth

52 Detent release beak

53 Second back-up resting plane

60 Elastic return element of the balance

61 Blade of the elastic return element of the balance

70 System for regulating the isochronism

71 Lever

72 Flexible pivot of RCC type

73 Adjustment table

74 Notches

75 Inclined plane

76 Apertures

77 Sacrificial fasteners

1. A mechanical timepiece regulator comprising a constant force escapement and an oscillator;
the oscillator comprising a balance connected to a balance elastic return element returning the balance into a plane of oscillation such that the balance is able to oscillate therein;
the escapement comprising an escapement wheel and an anchor part integrated in the balance;
wherein
the escapement comprises an entry pallet lever and an exit pallet lever, each being mounted on a pallet lever elastic return element configured to be wound by the escapement wheel;
the pallet levers being configured to block or release the escapement wheel between two windings of the pallet lever elastic return elements and to cooperate with the anchor part so as to transmit to the balance the energy stored in the pallet lever elastic return elements with each oscillation alternation of the balance.

2. The regulator according to claim 1, wherein each of the pallet levers comprises a pallet lever resting plane designed to cooperate with one of the teeth of the escapement wheel so as to block the escapement wheel during a resting phase of the regulator or to release the escapement wheel during an impulse phase of the pallet lever and a winding phase of the pallet lever elastic return elements.

3. The regulator according to claim 1, wherein each of the pallet levers comprises a pallet lever winding plane designed to cooperate with one of the teeth of the escapement wheel so as to wind the pallet lever elastic return element during a winding phase of the pallet lever elastic return elements.

4. The regulator according to claim 1, wherein each of the pallet levers comprises a pallet lever impulse plane designed to cooperate with the anchor part during a pallet lever impulse phase in which the pallet lever transmits its energy to the balance.

5. The regulator according to claim 1, wherein the escapement comprises an entry detent cooperating with the entry pallet lever and an exit detent cooperating with the exit pallet lever;
each of the detents comprising a flexible part having an end fixed to a fixed base and a part comprising a detent release plane cooperating with the pallet lever.

6. The regulator according to claim 5, wherein the anchor part comprises an anchor release beak configured to push onto the detent release plane of the detent so as to release the pallet lever during a release phase of the pallet lever.

7. The regulator according to claim 5, wherein each of the pallet levers comprises a pallet lever resting beak designed to cooperate with a detent resting plane of one of the detente so as to block the rotation of the pallet lever during a resting phase of the regulator and to release the pallet lever during a release phase of the pallet lever.

8. The regulator according to claim 1, wherein the elastic return element of the balance comprises two blades which intersect so as to form a flexible pivot of the Wittrick type.

9. The regulator according to claim 1, wherein the pallet lever elastic return element is formed from two intersecting flexible blades.

10. The regulator according to claim 1, comprising a system for tuning the isochronism configured to correct the isochronism defect of the elastic return element of the balance.

11. The regulator according to claim 5, wherein the system for tuning the isochronism comprises a lever which pivots so as to regulate the pivoting of the detent about a detent center of rotation and to regulate the preload torque between an abutment and the detent.

12. The regulator according to claim 1, wherein the pallet lever comprises a pallet lever arm cooperating with a second detent, the second detent comprising a rigid pallet lever part cooperating with one of the teeth of the escapement wheel.

13. The regulator according to claim 12, wherein the rigid pallet lever part comprises a detent release beak configured to cooperate with a release plane provided at one end of the pallet lever arm and an arm resting plane designed to cooperate with the teeth of the escapement wheel.

14. The regulator according to claim 13, wherein the rigid pallet lever part further comprises an abutment plane designed to bear against the fixed abutment when the second detect does not interact with the pallet lever.

15. A method for manufacturing the regulator, according to claim 8, comprising the steps of:
forming a first component comprising a blade of the elastic return element of the balance, a fixed base, the anchor part and one of the blades of the pallet lever elastic return element;
forming a second component comprising the further blade of the elastic return element of the balance, the other blade of the pallet lever elastic return element, and a felloe of the balance;
forming a third component comprising the pallet levers and the detents; and
assembling the first, second and third components.
